(19) United States
(12) Patent Application Publication
(10) Pub. No.: US 2004/0252966 A1
(43) Pub. Date: Dec. 16, 2004

(54) Video storage and playback system and method

(76) Inventors: Marty M. Holloway, Sacramento, CA (US); Rafael Moreno, Yuba City, CA (US); David Smith, El Dorado Hills, CA (US); Hye Kyung Kim, Richmond, CA (US)

Correspondence Address: M. David Galin, Renner, Otto, Boisselle & Sklar, LLP, Nineteenth Floor, 1621 Euclid Avenue, Cleveland, OH, 44115-2191, US

(21) Appl. No.: 10/458,047

(22) Filed: Jun. 10, 2003

(51) Int. Cl. H04N 5/781

(52) U.S. Cl. 386/46; 386/125

(57) ABSTRACT

A method of storing video data, a video capture module, and a video storage and playback assembly are disclosed. The method and assembly involve receiving an input video signal, decoding the input video signal and storing a video file corresponding to the input video signal. In addition, an interface for transferring data between a memory component where the video file is stored and a general use computer can be established.

### TECHNICAL FIELD

The present invention relates generally to the field of information storage and retrieval and, more particularly, to a highly portable device that is particularly well suited for storing video files and outputting a video signal corresponding to a stored video file for display on a separate display device.

### BACKGROUND

The use of video displays has become increasing widespread. Accordingly, more and more products are becoming available to display video images. For example, televisions, including conventional electron gun units, projection units, liquid crystal displays (LCDs), and plasma displays, have become widespread and are available in a variety of sizes. Some displays are adapted to be highly portable and rely on a battery power supply source. Many highly portable displays are implemented using LCD technology and have viewable screens that are generally in the range of about two inches to about nine inches. Other portable displays include head mounted displays (HMDs) that can use, for example, small LCD screens or a projector that projects an image towards the user's eye(s). As another example, passenger vehicles can come equipped with video displays for passengers to view during travel.

At present, the source of video content for display on these highly portable displays has been limited. Generally, video signals are derived from a media player, such as a digital video disk (DVD) player or a video tape player where the content stored by the disk or tape has been predetermined. To view content from the disk or tape, the user must have a display, an appropriate player and a medium (e.g., a disk or tape) storing the desired content. In some instances, the player and the display are integrated, such as in the form of a portable DVD player/LCD display assembly. Alternatively, video signals can be derived from a wireless broadcast, such as signals broadcasted by an antenna or a satellite. To receive the broadcasted signals, an appropriate receiving apparatus and/or tuner would be required. In many portable applications, the receipt of video signals, and especially high quality video reception, is difficult and limited by the person's location and ability to transport and power the needed equipment.

Personal computers have also been used to capture video files or download video files, and display images derived from those files on a display associated with the computer. Capturing video data (e.g., via a video interface card) generally requires specialized hardware and a relatively high skill level in using computer related equipment and software. Many computers can also be used to “burn” video files onto a writeable DVD from video files stored by a memory of the computer (e.g., a hard drive), but this also requires an appropriate hardware configuration and a relatively high skill level.

Other techniques for capturing video files on a medium have included, video cassette recorders (VCRs) that take video signals from a broadcast source (e.g., a conventional antenna broadcast, cable television vendor or satellite broadcast) and store those signals on a tape. In addition, some devices have been adapted to store broadcasted video signals using a digital format, such as on a hard drive. A video camera can also be used to generate video signals and store those camera generated signals in an analog format (e.g., on video tape) or digital format. However, the devices for storing broadcasted signals and camera generated files are designed for playing back the video files directly to a television. Therefore, a user often has difficulty transferring those video files to the memory of a general purpose computer for subsequent video processing (e.g., editing or conversion from two dimensional format to three dimensional format) or sharing over a network (e.g., by electronic mail or file transfer).

Therefore, there exists a need in the art for a highly portable device that can provide video signals to a similarly portable display. In addition, there is an equally high need for a device that can store video files derived from both external video sources (e.g., broadcasts, video cameras, VCRs, DVD players, etc.) and computing devices, as well as output video signals or corresponding files to traditional video hardware (e.g., displays and VCRs) and computing devices.

### SUMMARY OF THE INVENTION

According to one aspect of the invention, the invention is directed to a method of storing video data. The method can include a) providing a video storage/playback device having a re-writeable memory component, a video processor assembly, and a self contained electrical power source to enhance portability of the device; b) receiving an input video signal, the input video signal being in an analog format; c) decoding the input video signal; d) converting the input video signal to a digital format; e) storing the digital, decoded video signal on the memory component as a video file; f) establishing an interface for transferring data between the memory component and a general use computer; and g) retrieving the video file with the general purpose computer.

According to another aspect of the invention, the invention is directed to a video capture module. The video capture module can include at least one video input for receiving an input video signal; a video decoder for decoding the input video signal and outputting a decoded video signal in digital format; and a mating connector having plurality of electrical contacts for cooperatively engaging a video storage/playback device, and the decoder coupled to at least one of the electrical contacts to apply the decoded video signal to the at least one of the electrical contacts.

According to yet another aspect of the invention, the invention is directed to a video storage and playback assembly. The assembly can include a video capture module and a video storage/playback device. The video capture module can include at least one video input for receiving an input video signal; a video decoder for decoding the input video signal and outputting a decoded video signal in digital format; and a mating connector having plurality of electrical contacts for cooperatively engaging a video storage/playback device, and the decoder coupled to at least one of the electrical contacts to apply the decoded video signal to the at least one of the electrical contacts. The video storage/playback device can include a re-writeable memory component for storing a plurality of files; an input for receiving the decoded video signal; and a video processor assembly for converting the decoded video signal into a video file and storing the video file on the memory component.

### BRIEF DESCRIPTION OF DRAWINGS

These and further features of the present invention will be apparent with reference to the following description and drawings, wherein:

FIG. 1 is a front view of a video storage and playback device according to the present invention;

FIG. 2 is a right side view of the video storage and playback device;

FIG. 3 is a block diagram of the video storage and playback device in a first example operational configuration;

FIG. 4 is a block diagram of the video storage and playback device in a second example operational configuration;

FIG. 5 is a block diagram of the video storage and playback device in a third example operational configuration;

FIG. 6 is a block diagram of components used to implement an embodiment of the video storage and playback device;

FIG. 7 is a block diagram of a power board assembly of the video storage and playback device;

FIG. 8 is a block diagram of a video capture module for use with the video storage and playback device;

FIGS. 9A and 9B are a flowchart of exemplary operational logic for the video storage and playback device; and

FIG. 10 is a perspective view of a hinge mechanism for the video storage and playback device.

### DISCLOSURE OF INVENTION

In the detailed description that follows, corresponding components have been given the same reference numerals, regardless of whether they are shown in different embodiments of the present invention. To illustrate the present invention in a clear and concise manner, the drawings may not necessarily be to scale and certain features may be shown in somewhat schematic form.

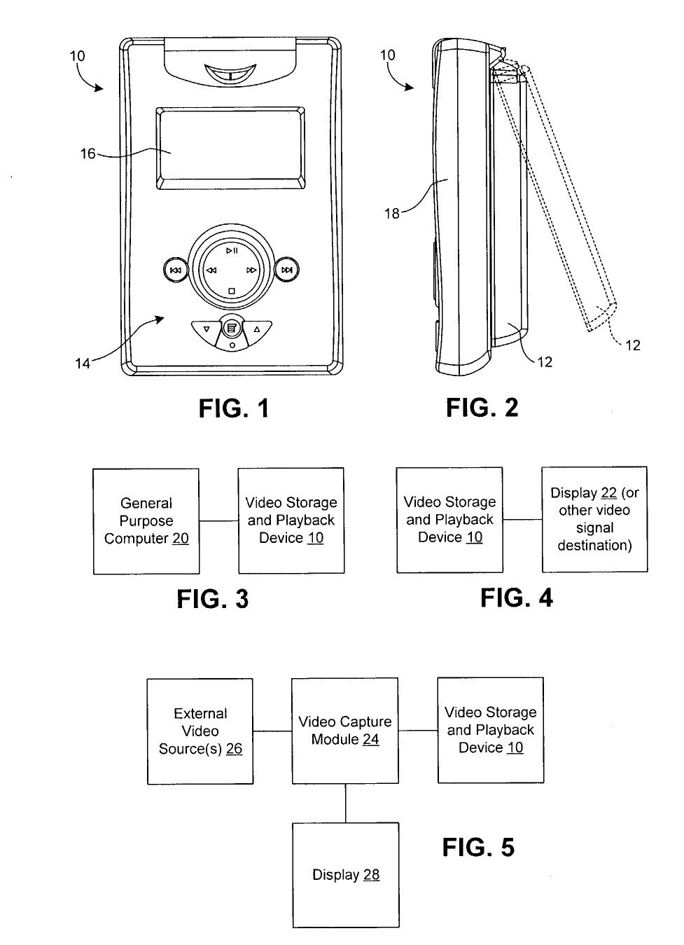

Referring initially to FIG. 1, shown is a front view of a video storage and playback device 10. The device 10 can be used to store video files and deliver video signals corresponding to the stored files to a display. The device 10 is highly portable in that the device 10 is relatively small (e.g., sized to be held in one's hand, such as about 84 mm wide by about 129 mm long by about 35.2 mm deep inclusive of a battery pack) and relatively light-weight. The device 10 can also include a rechargeable power supply for powering the device 10 when external power is not available. Audio files can also be stored and played back through a speaker(s) or headphones connected to the device 10.

Accordingly, the device is well suited for use in delivering video signals to a portable video display device, such as a portable liquid crystal display (LCD) panel, a head mounted display (HMD), a projector and so forth. As should be appreciated, the video signals output by the device 10 can also be used to drive less portable displays or systems, such as televisions, computers, and so forth.

The device 10 is adapted to receive incoming video signals from a variety of sources and in a variety of formats for storage on a memory component of the device 10. For example, the device 10 can be coupled to an input/output interface of a general purpose computer (e.g., using a universal serial bus, or USB). Files can then be transferred between the device 10 and the computer and/or between the device 10 and a network accessible by using the computer. The files exchanged between the computer and the device 10 can be, for example, in a digital format and can include, but are not limited to, video files, picture/image files, data files, software applications and so forth. Although the device 10 is capable of storing just about any type of file or data, the device 10 can be configured to recognize certain types of files, such as video files and/or audio files for subsequent playback.

In other arrangements, the device 10 can be configured to receive analog or digital video and/or audio signals from an outside source, including but limited to, a coordinating video capture module, a video camera, a video media playback device (e.g., a video cassette recorder (VCR), or a digital video disk (DVD) player), a video signal broadcast receiver (e.g., a conventional radio frequency (RF) television tuner, a cable TV receiver or satellite signal receiver), a radio tuner, and so forth. Once received, the video signals can be stored on a memory component for later retrieval, decompression, decoding, processing and/or output.

The video and/or audio signals files stored by the device 10 can be output in at least two ways. First, the video and/or audio files can be converted to an analog or digital video signal and output for display on a display device or other purpose, such as a recording by a VCR. Second, the files can be transferred to a device, such as a computing device, for storage (e.g., on a hard disk), editing, file sharing, e-mailing, and so forth.

The foregoing features of the device 10, as well as additional features described in greater detail below, effectively make the device 10 a convergence device that facilitates video data exchange between television/video technology and computing technology.

As used herein the term video file includes any analog or digital representation of an image or series of images for storage on a readable medium, such as optical disks, hard disks, tapes, floppy disks, magnetic memories and so forth. The video files can be used to store, for example, still pictures, full length movies, short video presentations, image sequences, two-dimensional video data, three-dimensional video data, audio signals and/or information, text, embedded instructions, computer programs, combinations of the foregoing, and so forth. The video files can be converted into a video signal, with or without an audio component, to be used by another device, such as a video display device.

With continued reference to FIG. 1, the device 10 can include a plurality of buttons 14 that a user can depress to control operation of the device 10. The buttons 14 can include a set of buttons for controlling video file playback, such as a play/pause button, a stop button, a fast forward button, a rewind button, a next track button and a previous track button. A record button optionally may be provided on the device 10. The buttons 14 can further include a set of buttons for carrying out file selection and management functions, including, for example, a select (or enter) button, a file or folder up button, a file or folder down button and a file access button for “jumping” among files and folders in a hierarchical file management system. The purpose and operation of each button will be described in greater detail below.

The device 10 can include a display 16, such as a segmented LCD. The display 16 is used for file management of the files stored by the device 10 and for providing status information to the user (e.g., battery life, presence of external power, file size and/or playback duration, time remaining to complete a file playback, recording start time and/or end time, track or scene number currently being played, and so forth). In general, the display 16 is not used to present video content from the files stored by the device 10 to the user.

When connected to an external display, the device 10 can generate on-screen display (OSD) data and prompts for presentation on the external display to further assist the user to manage files stored by the device 10 and/or to configure the device 10 to record a video signal from an external source. The OSD data can take the form of text information, prompts, help screens, iconic information and/or graphical user interface (GUI) features.

In an alternative embodiment of the device 10, a second display can be integrated with the device to present video images derived from video files stored by the device 10 to a user. In yet another embodiment, the display 16 can be used to present to a user information relating to file management and device status, as well as video images derived from stored video files.

With additional reference to FIG. 2, a right side view of the device 10 is shown. In one embodiment, a left side view of the device 10 is a mirror image of the right side view. Ornamental features of the device 10 should be apparent from the illustrations of FIGS. 1 and 2. The back of the device 10 does not have any significant ornamental features. However, the top and/or bottom may be curved as shown by example in the attached figures.

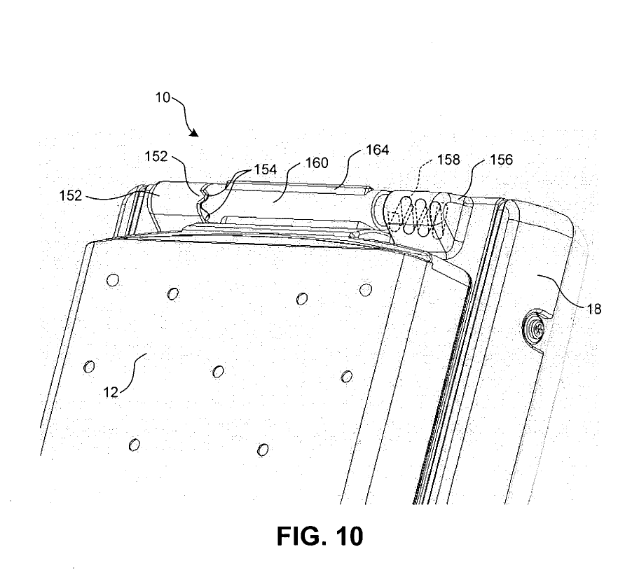

In one embodiment, a battery pack 12 can be removably hinged to a main body 18 of the device 10. In one embodiment, the hinge mechanism is assisted by a spring assembly to help “snap close” the battery pack 12 against the back of the main body 18 and to urge the battery pack 12 to an open position illustrated in dashed lines. With additional reference to FIG. 10, shown is a perspective view of a hinge assembly 150. The hinge assembly includes cooperating members of the main body 18 and the battery pack 12. The main body 18 includes a first strut 152 having at least one tooth 154 and a second strut 156 having a spring 158 (shown in phantom) disposed therein. The battery pack includes a generally cylindrical member 160 having notches 162 at a first end. The notches engage the tooth 154 to stabilize the battery pack 12 in either the open position or the closed position. The spring 158 engages a second end of the cylindrical member 160 to urge the notches 162 into engagement with the tooth 154. The notches 162 and the tooth 154 can include cam surfaces such that when a user lifts the battery pack 12, the battery pack 12 will rotate towards the open position and when a user pushes the battery pack 12, the battery pack 12 will rotate towards the closed position. A wedge 164 can be provided to minimize over-rotation of the battery pack 12 with respect to the main body 18.

The battery pack 12 can be detached from the main body 18 by pushing the battery pack 12 in a lateral direction to compress the spring 158 and to disengage the first end of the cylindrical member from the first strut 152. A twisting, lifting motion can then be used to free the battery pack 12 from the main body 18. It is noted that projections on the first and/or second ends of the cylindrical member 160 adapted to enter recesses in the struts 152, 156 may be present to assist in retaining the battery pack 12 in engagement with the main body 18.

Electrical connection can be established between the battery pack 12 and the main body 18 using mating contacts, such as curved metal conductors that rest against one another through rotation of the battery pack 12 with respect to the main body 18. If desired, the conductors can be bent to provide an elastic force to increase the engagement with corresponding conductors.

In the open position, which can orient the battery pack 12 at an angle of about 15 degrees to about 65 degrees with respect to the main body 18, the device can be stood upright on a surface with a bottom of the main body 18 and a bottom of the battery pack 12 resting on the surface. In one example embodiment, the open position orients the battery pack 12 at an angle of about 55 degrees with respect to the main body 18. In either the open or closed positions, electrical connection of batteries contained in the battery pack 12 to components of the main body 18 can be made.

In one embodiment, the battery pack 12 is interchangeable so that a user can replace a drained or damaged battery pack with a fresh battery pack. The size of the battery pack 12 may be changed to provide different battery life length options to a consumer of the device 10.

Referring now to FIG. 3, shown is a block diagram of the video storage and playback device 10 in a first example operational configuration. In the first operational configuration, the device 10 is coupled to a general purpose computer 20 by way of an input/output interface of the computer 20, such as a USB connection, or other interface that would allow the exchange of files. General purpose computers are relatively well known and will not be described in greater detail. The computer 20 can be, for example, a personal computer (e.g., a “laptop” or a “desktop” computer), a personal digital assistant (PDA) or the like. Usually, the computer 20 will include a processor(s), a non-volatile memory component(s), a volatile memory component(s), input/output interfaces, a network interface(s) (e.g., a modem and/or network interface card) and a local interface(s) for coordinating data exchange among these components (e.g., a bus or internal network). Various peripheral devices can be connected to the computer 20, including, but not limited to, a display, a mouse, a keyboard, speakers, a microphone, a camera (e.g., a digital still camera, an analog video camera or a digital video camera), a scanner, a printer and so forth.

In the embodiment of FIG. 3, the device 10 can be viewed as a data storage means for the computer 20. For example, the device 10 can be configured to appear as a memory device, such a hard drive, to the computer 20. In this regard, a user of the computer 20 can save files on the device 10 and/or transfer files to the device 10 for storage. As indicated, the files exchanged between the device 10 and the computer 20 can take on any file type that can be generally stored on a computer readable medium.

In addition, files can be retrieved from the device 10 using the computer 20. For example, files can be accessed by a software application executed by the computer 20, transferred to another memory associated with the computer 20 (e.g., a hard drive or a writeable disk, such as a writeable DVD), transferred to another computer by e-mail or file transfer mechanism, and so forth. Video files that are stored by the device 10 can be accessed by the computer 20 and video content contained in the video file can be displayed on a monitor associated with the computer 20. Alternatively, the computer 20, along with software executed by the computer 20, can be used to reformat, process and/or edit video files stored by the device 10. Similarly, audio files and audio components of video files that are stored by the device 10 can be accessed by the computer 20 and output to be heard by a user with speakers or headphones associated with the computer 20.

Referring now to FIG. 4, shown is a block diagram of the video storage and playback device 10 in a second example operational configuration. In the second operational configuration, the device 10 is coupled to a display 22. As should be appreciated, the display 22 can be any type of display for presenting visual images to a user. The display 22 can include or can be associated with speakers or headphones for presenting to the user an audio component corresponding to the displayed video.

Exemplary displays include, for example, televisions, projectors, computer monitors, head mounted displays, virtual reality displays, and so forth. Televisions can include conventional electron gun televisions, projection televisions, plasma televisions, LCD televisions and any other video display apparatus. As indicated, the device 10 is particularly well suited for providing video signals to portable display devices, such as small LCD screens and head mounted displays (e.g., a wearable device for projecting, reflecting or targeting an image towards a user's eye or eyes).

In alternative arrangements, the display 22 can be substituted with or connected by way of another video signal handling device. Such video signal handling devices could include a video signal recording machine (e.g., a VCR), a signal amplifier, a stereo glasses controller for coordinating the viewing of three-dimensional video content, and so forth.

The connection from the device 10 to the display 22 can take any appropriate form, including any analog or digital video standard interface. Examples include, but are not limited to, component video, composite video, S-video, coaxial cable, RCA connectors, 15 pin mini D-SUB, and so forth.

Referring now to FIG. 5, shown is a block diagram of the video storage and playback device 10 in a third example operational configuration. In the third operational configuration, the device 10 is coupled to a video capture module 24, which in turn is coupled to an external video source 26.

The external video source 26 can be any device or system that can output a video and/or audio signal, and can include multiple devices and/or systems. Examples include a video tuner for receiving a broadcasted video signal (including, for example, antenna broadcasts (RF transmissions), cable delivery and satellite broadcasts), a video camera, a playback device (e.g., a VCR, a DVD player, a CD player, an MP3 player, etc.), a computer, an audio tuner (e.g., a radio) and so forth. As should be appreciated, many devices that are capable of functioning as an external video source 26 can also be configured to receive a video signal.

The video signal output by the external video source 26 is input to the video capture module 24. The video capture module 24 can be configured as a “cradle” for the device 10. For example, the video capture module 24 can be physically arranged as a base into which the device 10 at least partially fits. When the device 10 is engaged with the video capture module 24, electrical contacts of the device 10 can establish electrical connection with corresponding electrical contacts of the video capture module 24 such that various signals can be exchanged between the device 10 and the module 24. The device 10 can be conveniently brought out of engagement with the video capture module 24 by simply lifting the device 10.

The video capture module 24 can receive analog or digital video input signals. The input video signals are passed through a decoder that provides a corresponding digital video signal to the device 10 for storage by a memory of the device 10. The digital video signal provided to the device 10 can include an audio component. A separate digital audio component, based on audio and/or video signals received by the video capture module 24, also can be provided from the video capture module 24 to the device 10.

The video capture module 24 can also function as a pass through device. That is, video and/or audio signals input to the video capture module 24 can be directed to a display 28, in most cases without processing or format change. In this manner, the presence of the video capture module 24 can be transparent to a user who wishes to view video content on the display 28 that originates from the external video source 26.

In addition, video files stored by the device 10 can be played-back to generate a video signal that is directed to the display 28 from the device 10, but through the video capture module 24. If desired, the video signal output by the device 10 also can be directed to the external video source 26 through the video capture module 24 for recording (e.g., using a VCR), storing (e.g., using a computer), etc. In this arrangement, appropriate cable connections can be established between the external video source 26 and the video capture module 24 and between the video capture module 24 and the display 28.

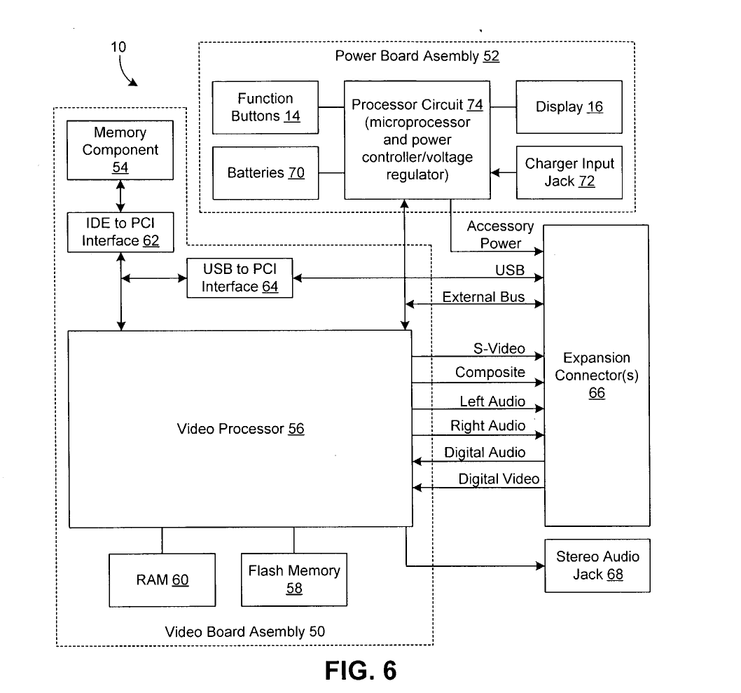

Referring now to FIG. 6, a block diagram of components used to implement an embodiment of the video storage and playback device 10 is illustrated. In the illustrated embodiment, the device 10 includes a video board assembly 50 and a power board assembly 52. The video board assembly 50 can include a memory component 54 for storing compressed or uncompressed files, including, but not limited to, video files, audio files, data files, software applications, and so forth.

In one embodiment, the memory component 54 is implemented using a hard disk and drive assembly, such as an industry standard 2.5 inch IDE hard drive. In one embodiment, the memory component has a data storage capacity of about 20 gigabytes to about 1,000 gigabytes. A memory component 54 having a data storage capacity of about 30 gigabytes can store about 15 hours of video data in MPEG-2 format (e.g., the equivalent of about 5 to 7 full length feature movies). However, other data storage capacities and other type of memories are contemplated. Other types of memory components can include, for example, various magnetic memories, flash memories, optical memories, and so forth. The memory components 54 can be implemented as a volatile memory, however, it is preferred that the memory component 54 is implemented as a nonvolatile memory.

The video board assembly 50 can include a video processor 56 for executing logic instructions, for example, in the form of code or software applications, so that various functions of the device 10 can be carried out. The video processor 56 can execute logic to carry out a wide variety of complex video processing functions and, therefore, can be implemented with a relatively powerful processor, such as a PNX1301 available from Philips Semiconductor of Eindhoven, The Netherlands. In one embodiment, the processor is clocked at greater than 100 MHz, such as about 165 MHz, which can be three times the PLL of a 55 MHz clock provided by support circuitry for the video processor 56. The video processor 56 can also be implemented as a larger assembly, including a logic execution processor (e.g., a PNX1301 microprocessor chip), a video encoder (e.g., a SAA7121 video encoder available from Philips Semiconductor) and an audio digital to analog (D/A) converter (e.g., a CS4334 audio D/A converter available from Cirrus Logic of Austin, Tex.).

Example functions carried out by the processor 56 include various types of manipulation of video signals as the video signals are received by the video processor 56 for storage on the memory component 54 or as video data is read from a video file stored by the memory component 54 to generate an output video signal. Example video data manipulations include video decoding or encoding into or from various formats including, for example, analog signals, MPEG-1, MPEG-2, MPEG-4, AVI, Div-X, and so forth. Similar decoding functions for audio signals, such as MP3 stereo audio decoding, JPEG still image decoding and the like can be carried out. Other functions include video file and audio file (e.g., MP3 files or WAV files) playback.

Additional functions carried out by the video processor 56 can include resizing or re-scaling of a video image, such as from VGA to SVGA or from D1 to QSIF. Another function can include converting two dimensional image sequences to three dimensional image sequences. The processor 56 can also be used to increase or decrease the resolution of video data. Another function can include converting from one video file format to another video file format such as from MPEG-1 to AVI or from MPEG-4 to Div-X. Yet other processing functions can include line doubling, adding color or bar code information to a file to tag the file or a portion thereof as containing three dimensional video sequences, reformatting three dimensional video sequences for use by a LCD projector, changing the timing of NTSC signals so that successive fields will write to the same line in an attempt to reduce flicker in three dimensional applications and other processing that would enhance or enable three dimensional viewing of a video file.

Other functions could include using the device 10 with a still or video camera to feed image data to the video processor 56 and use the video processor 56 to capture one or more images. The captured images can be saved as still picture files or video files on the memory component 54. In a similar manner, the video processor 56 could be used to capture incoming audio signals and save those signals in the form of an audio file on the memory component 54. The programming associated with the video processor 56 can include “hooks” so that code for carrying out various additional functions can be added.

Another function that can be performed by the video processor 56 is compression of files to be stored on the memory component 54 and/or decompression of files read from the memory component 54. Similarly, the video processor 56 can perform encryption and/or decryption of files to be stored on or retrieved from the memory component 54. The various functions performed by the video processor 56 can be conducted in real time (e.g., as video data is input to the video processor 56 or output from the video processor 56) or in a background mode that is not simultaneous with the input or output of video data. Incoming video signals can also be converted into a custom format for storage on the memory component 54 and unconverted when retrieved from the memory component 54. This function can assist in enabling the use of proprietary or yet to be developed data compression techniques, file formats and so forth. As should be appreciated, additional functions not explicitly specified herein can be performed by the video processor 56.

In one embodiment, the processor 56 can execute software applications typically executed by a personal digital assistant (PDA) or general purpose computer. For example, the device 10 can include a datebook/calendar function, an address book function, a calculator function, an e-mail function, a word processing function, a spreadsheet function, and so forth.

The code and/or software applications executed by the video processor 56 can be stored using the memory component 54. This arrangement allows for upgrading the code and/or software, reloading or reinstalling of the code and/or software (e.g., for system recovery purposes), the addition of updates to the code and/or software, and the like. In one embodiment, modifications and/or additions to the code and/or software can be carried out using an install shield. Multiple executable logic routines can be stored by the memory component 54. The device 10 can be configured such that the user can elect which executable logic routines are executed at a give time. Example logic routines include a device 10 record/playback routine, a video editing routine and so forth. In addition, third party applications can be stored by the memory component 54 for execution by the video processor 56.

A second memory component, such as a flash memory 58, can be used to store additional information, files and/or executable routines. A random access memory (RAM) 60 can also be provided to assist the video processor 56 in executing various logic routines as should be apparent to one of ordinary skill in the computing arts. Various internal interfaces, busses, and converters can be employed to establish operational connectivity among the devices of the video board assembly 50. For example, the memory component 54 can be coupled to the video processor 56 by way of an IDE-PCI interface chip 62, such as a PCI0643.

As indicated, the device 10 can be connected to a general purpose computer in a manner that presents the device 10 as a storage medium to the general purpose computer. In one embodiment, the video board assembly 50 can include a USB to PCI converter 64, such as a UPD720130 bridge chip available from NEC Corporation of Tokyo, Japan, to establish an interface between the video processor 56 and a USB port or other USB compatible connector assembly. As a result, a physical and operational connection with a corresponding port of the general purpose computer can be established. It should be apparent to those with ordinary skilled in the art that other types of interfaces other than USB standard interfaces can be used as an alternative to this configuration. The interfaces may be by direct electrical connection, wireless connection, optical connection, or any other connection. The device 10 can be configured to interface with the general purpose computer strictly as a data storage means (e.g., without performing any functions by the video processor 56) or as a value-added device to store and process data files, particularly, video files (e.g., by executing one or more of the functions described above). Alternatively, the device 10 can be connected to the computer 20 as a networked device (rather than as a peripheral).

The interface for connection to a general purpose computer, or another interface of the video board assembly 50, can be used to establish an operational connection to other devices. For example, a keyboard, a printer, a scanner, a still or video camera, a modem or networking card (including wireless and hard wired varieties of modems and networking devices), a mouse, and so forth.

The video board assembly 50 and particularly the video processor 56, can interface with external devices by way of one or more electrical connectors, jacks, optical interfaces, and so forth. In the illustrated embodiment, the device 10 includes at least one expansion connector 66 having a plurality of pins or electrical contacts accessible from outside the main body 18 (FIG. 1) of the device 10 (e.g., disposed along a bottom surface of the main body 18). In one embodiment, the expansion connector 66 is a fifty pin array to which wires can be connected or to which mating connectors of the video capture module 24 can connect.

As illustrated by example in FIG. 6, the expansion connector 66 can include an S-video output, a composite video output, left audio channel output, right audio channel output, digital audio input from the video capture module 24 (e.g., an inter-IC sound service bus or I2S), a digital video input from the video capture module 24 (e.g., a Consultative Committee for International Radio 30 (CCIR) 601 or 656 connection), a USB interface (e.g., under the USB 2.0 standard), an external bus interface (e.g., an inter-IC, or I2C, interface) for the exchange of data and/or commands with the video capture module 24 or other accessories, and an accessory power interface for receiving power to operate the device 10, to charge batteries associated with battery pack 12 (FIG. 2) or to provide power to a connected accessory (e.g., a head mounted display).

As should be appreciated, the illustrated interfaces established using the expansion connector 66 are exemplary and one or more interfaces can be omitted, interfaces can be added, and interfaces can be substituted for those shown. For example, a component video interface could be added. In addition, the various interfaces need not be coordinated through a single integrated expansion connector 66 but could include multiple interfaces using a variety of standard and/or non-standard connector types. For example, to conveniently connect speakers or headphones to the device 10, an audio jack 68 (or jacks) can be provided.

In the embodiment where the expansion connector 66 is in the form of an array of pins or connectors, wiring can be provided with a connector on a first end adapted to interface with the expansion connector 66 and one or more connectors on a second end that are mechanically and electrically compatible with standard interfaces of various devices (e.g., displays, external video sources, computing devices, and so forth).

As indicated, the device 10 can include a power board assembly 52. The power board assembly 52 supplies power for operation of the video board assembly 50 and, if appropriate, accessory devices coupled to the device 10 using accessory power portions of the expansion connector 66. The power board assembly 52 can also include circuitry and/or a processor to execute code for managing operation of the device 10, such as coordinating a user interface, send commands to the video processor 56 and so forth. For these purposes, the power board assembly 52 can include the function buttons 14, the display 16, one or more batteries 70, a charger input jack 72, and a processor circuit 74. The processor circuit 74 can include a micro processor, such as a PIC16C925 clocked at 4 MHZ, as well as power control and voltage regulation devices.

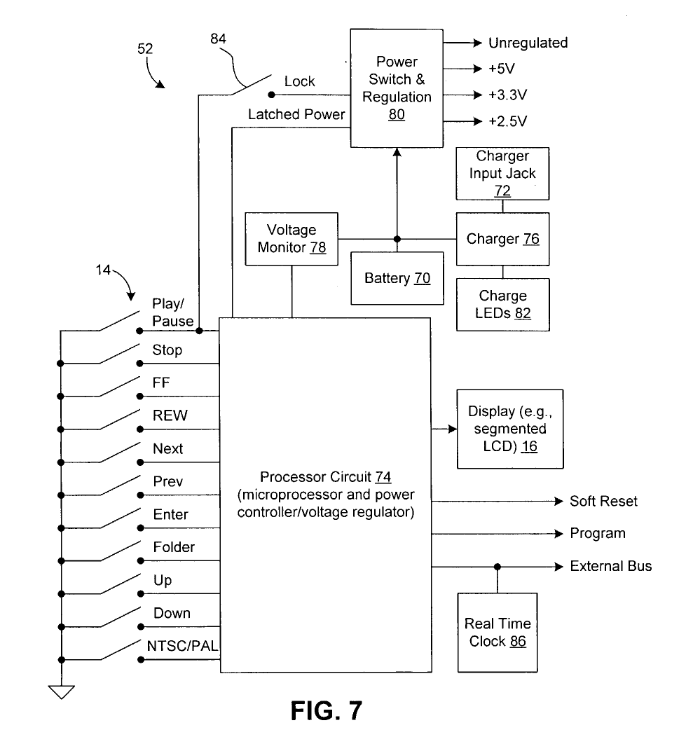

With additional reference to FIG. 7, the power board assembly 52 will be described in greater detail. FIG. 7 illustrates a more detailed block diagram of an example embodiment of the power board 52 for the device 10. Electrical power from an external source can be input to the power board assembly 52 through the charger input jack 72. Power may also be received from the video capture module 24 when the device 10 is engaged therewith. External power can be applied to a charger 76 used to refresh and/or recharge the battery 70. The charger 76, in connection with a voltage monitor 78, a power switch and regulation circuit 80 and power controller/voltage regulator components of the processor circuit 74, can be used to regulate the charging of the batteries 70. In addition, these components can be used to govern the supply power from the batteries 70 or an external source to the rest of the device 10 and/or to accessories (e.g., a head-mounted display) that are connected to the device 10 and derive power therefrom. Accordingly, the power switch and regulation circuit 80 can have one more voltage outputs, such as the illustrated unregulated output, a plus 5 volt output, a plus 3.3 volt output and a plus 2.5 volt output. Charge LEDs 82 can be provided to give a visual indication of the charge status of the batteries 70 and whether external power is presently applied to the device 10. The battery 70 can be implemented with one or more lithium polymer batteries (e.g., a pair of lithium polymer batteries connected in series and physically located in the battery pack 12).

Supply of power to the various components of the device 10 can be controlled by a high current MOSFET switch 84 that is enabled by a user depressable button, such as the play/pause button. The switch 84, and hence the supply of power, can be latched “on” by the processor circuit 74. When turned on, a user can interact with the device 10 by pressing various buttons 14 of the device 10. One button can be an NTSC/PAL button for placing the device in either an National TV Standards Committee (NTSC) mode compatible with NTSC video standards, such as those found in the United States, or in a phase alternating line (PAL) mode so that the device 10 is compatible with PAL video standards, such as those found in various European, African, South American, Middle Eastern and Asian countries. The device 10 can also be configured to operate in a Systeme En Couleur Avec Memoire (SECAM) mode so that the device 10 is compatible with SECAM video standards, such as those found in various eastern European countries, African countries, and Middle Eastern countries, as well as France and Russia.

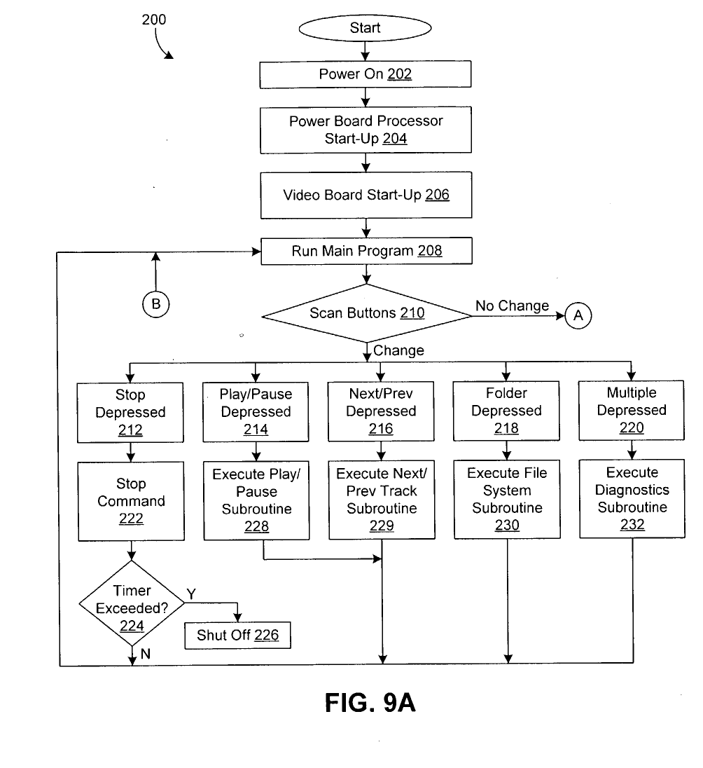

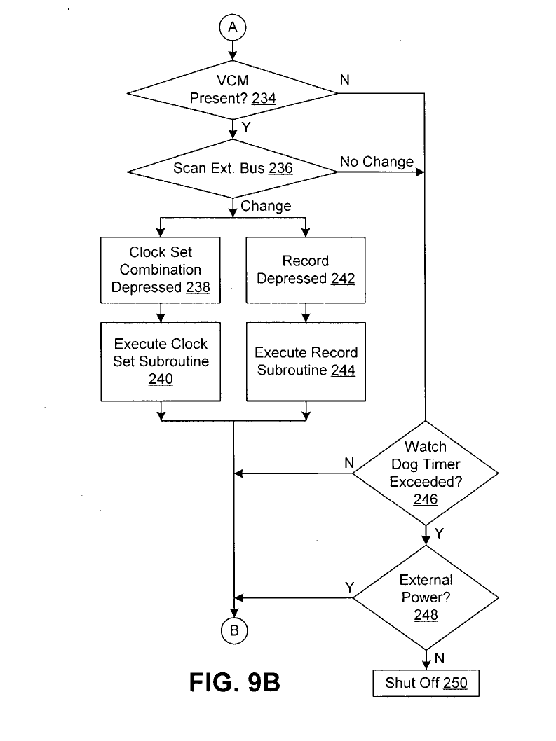

A processor portion of the circuit 74 can execute logic to carry out operational functions of the device 10 and provide a user interface. For example, the functionality processor component can execute logic stored by the flash memory 58 of the video board assembly 50. The logic executed by the processor circuitry can also be stored by the memory component 54 of a memory (not shown) of the power board assembly 52. Logic to execute a user interface through the buttons 14 will be described in greater detail below with respect to FIG. 9.

Iconic symbols and other alphanumeric information can be presented to the user on the display 16. In one embodiment, the display is implemented as a segmented LCD screen, such as a four column by seventeen segment, multiplexed display. In one embodiment, the display 16 is monochrome. As indicated above, more sophisticated displays 16 can be provided and can also be used to display still and video images to the user.

The power board assembly 52 can be provided with a switch or other mechanism for conducting a soft restart of the device 10 in the event that the device “locks up”. A physical or logical program switch can also be provided so that software executed by the functionality processor component of the circuit 74 and/or the video processor 56 can be installed, upgraded, re-installed, removed, or appended. In one embodiment, this reprogramming of the device 10 can include re-flashing the memory 58, or any other flash type memory present in the device 10. Alternatively, the programming operation can include writing files to the memory component 54 or other re-writeable memory component. The functionality processor component of the circuit 74 can also be coupled to an external bus that links the processor circuit 74 with the video processor component 56. If appropriate, the external bus can link the processor circuit 74 to the expansion connector 66 for interfacing with an external device. In one embodiment, the processor circuit 74 can execute logic to present on-screen display (OSD) information, prompts and menu options to a user on an external display. For example, commands can be transmitted from the processor circuit 74 to the video processor 56, which, in turn, converts the commands into video data that is output to the external display via the expansion connector 66.

A real time clock 86 can be provided to assist in clocking and timing functions of the device 10. For example, information derived from the real time clock 86 can be used to execute a timed recording function as programmed by the user to record an input video signal beginning at a specified time and/or stopping at a specified time.

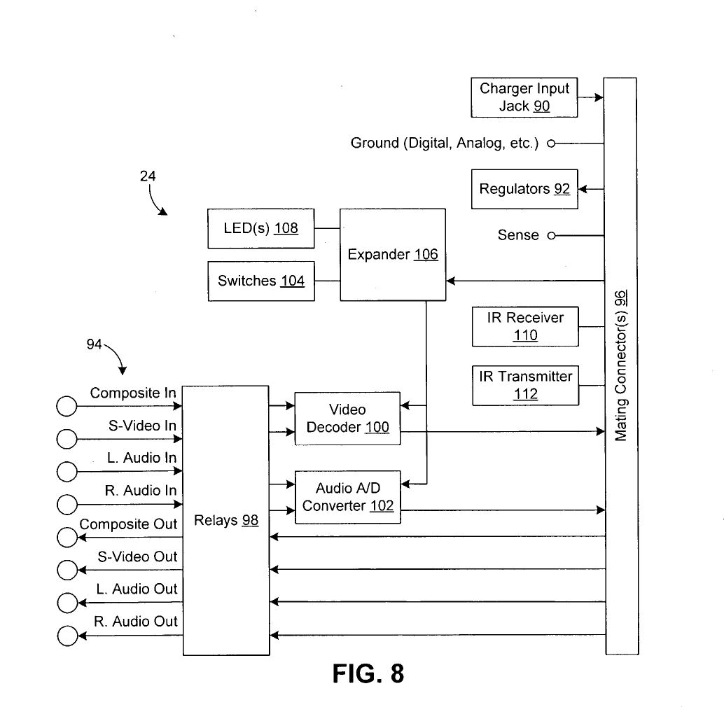

Referring now to FIG. 8, shown is a block diagram of an example embodiment of the video capture module 24. The video capture module 24 can include a charger input jack 90 for receiving electrical power used to power the video capture module 24 and/or to supply electrical power to the device 10 when the device 10 is engaged with the video capture module 24.

In one embodiment, the video capture module 24 can be provided with a set of mating connector 96 (or set of connectors) that mechanically and/or electrically cooperate with the expansion connector 66 of the device 10 so that signals and electrical power can be exchanged between the video capture module 24 and the device 10. To provide further electrical compatibility between the video capture module 24 and the device 10, various ground lines (e.g., digital and analog grounds), as well as power supply regulators 92 can be provided. A sense line to detect connection of the device 10 to the video capture module 24 also can be provided.

The video capture module 24 can be provided with various video and/or audio input/output jacks, plugs, and connectors, which will be referred to collectively herein as input/output connectors 94. Output connectors from the input/output connectors 94 (such as the illustrated composite video output, S-video output, and left and right audio outputs) can be connected to the mating connector 96 through a series of relays 98. In this manner, video and audio signals output by the device 10 can be coupled to external devices through the video capture module 24. In addition, the relays 98 can be configured to pass through video and/or signal signals from the input connectors from the input/output connectors 94 to the output connectors from the input/output connectors 94. Video and/or audio input signals received at the input connectors 94 of the video capture module 24 can be switched through the relays 98 respectively to a video decoder 100 and an audio analog to digital (A/D) converter 102. Outputs of the video decoder 100 and the audio A/D converter 102 can be connected to the mating connector 96 for respective connection to digital video input lines of the video processor 56 and digital audio input lines of the video processor 56. In one example, the output of the video decoder 100 is a CCIR 656 standard interface and the output of the audio A/D converter 102 is a I2S standard interface. The video decoder 100 can be implemented using a SAA7113 video decoder chip available from Philips Semiconductor and the audio A/D converter can be implemented using a CS5331A audio A/D converter from Cirrus Logic. In the illustrated configuration, audio and/or video decoding is performed by the video capture module 24. However, in other embodiments this functionality can be performed by the device 10. The video decoder 100 and the audio A/D converter 102 can be configured to be controlled by the video processor 56 and/or the processor circuit 74. Therefore, the external bus (FIG. 6) can be extended through the expansion connector 66 to the mating connector 96 for connection to the video decoder 100, and/or the audio A/D converter 102. In one embodiment, the external bus of the video capture module 24 can be implemented using an I2C standard interface.

The video capture module 24 can be provided with a set of switches or buttons 104 for controlling operation of the video capture module 24 and/or the device 10 by user action. In one embodiment, the buttons 104 are implemented as push buttons and correspond to each of the buttons 14 provided on the device 10. Alternatively, a reduced set of buttons can be provided on the video capture module 24 and/or buttons for invoking functionality not found on the device 10 can be provided (e.g., a record button can be added) An expander 106, such as a MCP23016 I2C 16-bit port expander chip, can be used to generate signals corresponding to changes in button state for delivery to the device 10 over the external bus. The expander 106 also can be used to drive a visual indicator, such as LEDs 108 or other display (e.g., an LCD) mounted on the video capture module 24 to provide status information to a user.

The video capture module 24 can include a receiver, such as an infrared (IR) receiver 110 to receive command signals from a remote device, such as a user operated remote control. The video capture module 24 can include a transmitter, such as an IR transmitter 112, for outputting command signals. The command signals output by the IR transmitter 112 can be used to control peripheral devices, such as a pair of stereo glasses that can be toggled between a 2D viewing mode and a 3D viewing mode. As is known in the art, stereo glasses can typically include a left and a right shutter lens (e.g., an active LCD lens), each of which can be placed in an open position or closed position to control the presentation of displayed images to the left and right eyes of a user viewing a display. In this manner, the video capture module 24, along with the device 10, can form a part of a 3D viewing system.

Referring now to FIGS. 9A and 9B, shown is a flowchart of exemplary operational logic 200 of the video storage and playback device 10 as controlled by the user depressing the various buttons 14 and/or buttons 104. The logic 200 starts in block 202 when device 10 is turned on. In one embodiment, the device can be turned on by the user depressing a play/pause button (FIG. 7) for a given period of time. Next, in block 204, the processor circuit 74 of the power board assembly 52 starts up by commencing execution of code to implement the logic 200. In block 204, startup functions can be carried out, such as asserting power on throughout the device 10, initializing the display 16, de-asserting a video board assembly 50, reset, and so forth. Next, in block 206, the video processor 56 and other video board assembly 50 components can be started up by, for example, loading executable software, determining the position of the NTSC/PAL switch and so forth.

In block 208 a main program can be executed. The main program can include operations that continually run when the device 10 is on, such as driving the display 16, accessing the real time clock 86, monitoring battery 70 power levels and/or charging the batteries 70.

The logic 200 can scan the buttons for a change in button 14 status (e.g., the user depressing one or more buttons) in block 210. If a change in button 14 status is detected in block 210, the logic 200 proceeds to an appropriate corresponding block 212 through 220. For example, in block 212 if the stop button is depressed, the logic 200 can proceed to block 222 where a stop command is executed. A stop command can include stopping playback of a file stored by the memory component 54. If, in block 224, the stop button is depressed for longer than a predetermined duration (e.g., about three seconds), the device 10 can be shut off in block 226. If the threshold duration in block 224 is not exceeded, the logic 200 can return to executing the main program of block 208.

Returning to block 210, if depression of the play/pause key is detected, the logic 200 can proceed to block 214 which invokes execution of a play/pause subroutine in block 228. Depression of the play/pause button for a first time will commence playback of a selected file from the memory component 54. As should be apparent, during playback of a file, if the play/pause button is depressed again, the playback will pause until the play/pause button is depressed once again. If the stop button is pressed during playback, the stop command block of 222 can be executed. In addition, during playback the depression of the fast forward button or the rewind button will advance or rewind the playback until the depressed button is released or pressed again, as is appropriate. During playback, the user can also depress the next track button or the previous track button to jump from the file or track currently being played respectively to a subsequent file or track or to a previous file or track.

If, in block 210, the logic 200 detects that the next track or previous track button is depressed, the logic 200 in block 216 will enter a next/previous track subroutine in block 229. The next/previous track subroutine can include detecting which of the next track or the previous track button was depressed, and the device 10 can appropriately change selection of a presently selected file or track to a subsequent or previous track or file.

If in block 210, the logic 200 detects depression of a folder button, the logic of block 218 can invoke execution of a file system subroutine in block 230. Within the file system subroutine of block 230, the user can use the up button, the down button, the enter button, and the folder button to select and deselect files stored by the memory component 54. The folder and enter buttons can be used to navigate through a file management system. The file management system can use OSD menus, information, prompts and screens to present the contents of the memory component 54 in a logical manner to the user. In addition, the user can use various buttons of the device 10 to perform various file management functions such as copying files, deleting files, naming files and so forth. In one embodiment, the file management system can arrange files stored by the memory component 54 in hierarchical format as is well known in the computing arts.

If in block 210 the logic 200 detects depression of more than one key at once, the logic can proceed to block 220, which invokes execution of a diagnostic subroutine in block 232. Depending on which keys are simultaneously pressed by the user, the diagnostic subroutine carries out various functions. For example, one pair of buttons can be used to reset or update the display 16. As another example, a pair of buttons can be used to enter a clock set mode where the date and time maintained by the real time clock 56 can be changed.

If in block 210 the logic 200 does not detect any changes to the state of the buttons 14, the logic 200 can proceed to block 234 where the logic 200 determines if the video capture module 24 (or VCM) is connected to the device 10. If the video capture module 24 is present and connected to the device 10, the logic can continue in block 236 where the external bus is scanned to determine if the user has depressed any buttons 104 associated with the video capture module 24. For example, the user may depress buttons 104 associated with a clock function and the logic 200 will proceed to block 238 where the logic 200 will enter a clock set subroutine in box 240. The clock set subroutine can include updating the time and date stored by a clock of the video capture module 24 or of the real time clock 56 of the device 10. In addition, timed record features, such as setting a record start time and/or stop time, a date for recording to take place, and/or a video signal source to record from, can be programmed using various keys and assisted by OSD prompts.

If, in block 236, the logic 200 detects that the user has depressed a record button associated with the video capture module 24 or the device 10, the logic 200 will proceed to block 242 where the logic 200 will enter a record subroutine in block 244. The record subroutine also can be entered if a user defined record start time has arrived. The record subroutine can involve capturing a video signal input to the device 10 by way of the video capture module 24. For example, the video processor 56 can acquire the incoming signal, convert that signal to a digital format (if appropriate), manipulate and/or process the video signal (e.g., perform such functions such as converting image sequences from a two dimensional format to a three dimensional format, resizing or re-scaling of the images contained with in the video signal, or the like), compressing the video signal or digital version thereof and so forth. In addition, the record subroutine can include storing the video information in the form of a video file (e.g, an MPEG file, a Div-X file, or the like) on the memory component 54. As should be appreciated, the stored video file can include an audio component. Alternatively, the video capture module 24 and device 10 can be used in conjunction with one another to record a still image (e.g., such as in a JPEG format), an audio signal (e.g., as in a MP3 file or WAV file) or any other incoming signal as a file on the memory component 54. Upon exiting either the clock set subroutine or the record subroutine, the logic 200 can return to executing the main program in block 208.

If, in block 234, the video capture module 24 is not present and connected to the device 10, or if, in block 236, no changes to the state of the buttons associated with the video capture module 24 are detected, then the logic 200 can proceed to block 246. In block 246 the logic determines whether a watchdog timer duration has been exceeded. In an example embodiment, the timer can have a duration of about five minutes. If this duration has not been exceeded the logic can return to executing the main program in block 208. However, if the timer duration has been exceeded in block 246, the logic can proceed to block 248 to determine if external power is currently being supplied to the device 10. If there is a supply of satisfactory external power, the logic 200 can return to block 208 for continued execution of the main program. However, if external power is not present in block 248, it can be assumed that the battery 70 is powering the device 10 and, to conserve the charge stored by the battery, the device can be shut off in block 250.

The flowchart of FIGS. 9A and 9B shows portions of the operation of the device 10. Various routines associated with the flowchart of FIGS. 9A and 9B can be viewed as depicting steps of a method implemented in the device 10. Logic carrying out these various functions can be embedded in software or code executed by the functionality processor from the circuit 74 and/or the video processor 56. Also, any portion of a software or code can be embodied in a computer readable medium for use by or in connection with an instruction execution system such as, for example, a processor. Alternatively, these functions can be embedded in firmware, contained as part of another device (e.g., the video capture module 24), or embodied in dedicated hardware. As one skilled in the art will appreciate, the flowchart of FIGS. 9A and 9B is exemplary and alternative descriptions and illustrations of the functionality described herein and falling within the scope of the claims appended hereto can be made.

Although the illustrations appended hereto show a specific order of executing functional logic blocks, the order of execution of the blocks can be changed relative to the order shown. Also, two or more blocks shown in succession can be executed concurrently or in partial concurrence. Certain blocks also may be omitted. In addition, any number of comments, state variables, warning semaphores or messages can be added to the logical flow for the purposes of enhanced utility, accounting, performance, measurement, or for providing troubleshooting aids, and the like. It is understood that all such variations are within the scope of the present invention.

Although not illustrated, the operational logic 200 can include operations for enabling compatibility with a computing device (e.g., the general purpose computer 20 of FIG. 3). For example, an IDE bus connected to the memory component 54 can be shared by the interfaces 62 and 64 through hardware multiplexing. If an external USB connection is detected by the video processor 56, any ongoing video and/or audio processing can be stopped and the hardware multiplexers can be switched to enable a USB to IDE bridge. In this manner, the computer coupled to the device 10 can access the memory component 54. When the computing device is disconnected from the device 10, the video processor 56 can resume audio and/or video processing through a command set of the processor circuit 74.

As should be appreciated from the foregoing discussion, the video storage and playback device 10 and the video capture module 24 can be used to seamlessly capture and store analog and/or digital video signals (e.g., the output of a video camera) and exchange files with a computing device. Files stored by the device 10 can be played back for viewing on a television or other display.

It will be appreciated that features that are described and/or illustrated with respect to one embodiment may be used in the same way or in one or more similar ways in other embodiments.

Although particular embodiments of the invention have been described in detail, it is understood that the invention is not limited correspondingly in scope, but includes all changes, modifications and equivalents coming within the spirit and terms of the claims appended hereto.

What is claimed is:

1. A method of storing video data, comprising:
a) providing a video storage/playback device having a re-writeable memory component, a video processor assembly, and a self contained electrical power source to enhance portability of the device;
b) receiving an input video signal, the input video signal being in an analog format;
c) decoding the input video signal;
d) converting the input video signal to a digital format;
e) storing the digital, decoded video signal on the memory component as a video file;
f) establishing an interface for transferring data between the memory component and a general use computer; and
g) retrieving the video file with the general purpose computer.

2. The method according to claim 1, wherein b), c) and d) are carried out by a video capture module.

3. The method according to claim 2, wherein the video capture module and the video storage/playback device comprise a first self contained unit and a second self-contained unit.

4. The method according to claim 1, further comprising storing at least one non-video file with the memory component, the non-video file being at least one of a data file, an audio file, an application specific file, a software application and combinations thereof.

5. The method according to claim 1, further comprising writing an additional file to the memory component with the general purpose computer.

6. The method according to claim 1, further comprising playing back the video file, wherein playing back the video file includes:
reading the file from the memory component;
encoding the video file; and
outputting the encoded video file in a format for display on a display device.

7. The method according to claim 1, wherein the video file contains data relating to a series of images adapted for display on a display device and an audio component.

8. The method according to claim 1, wherein the memory component is a hard disk and drive assembly.

9. The method according to claim 1, further comprising bringing conductors of an expansion connector of the video storage/playback device into cooperative engagement with conductors of a mating connector of a video capture module.

10. The method according to claim 9, wherein b), c) and d) are carried out by the video capture module.

11. The method according to claim 1, further comprising executing code with the video processor assembly to process video data of the video file.

12. The method according to claim 11, wherein the executed logic carries out at least one of resizing of the video data, resealing of the video data, and combinations thereof.

13. The method according to claim 11, wherein the executed logic converts the video data from two dimensional imaging to three dimensional imaging.

14. The method according to claim 11, wherein the executed logic converts the video file from a first file format to a second file format.

15. The method according to claim 11, wherein the executed logic compresses and decompresses the video file.

16. A video capture module, comprising:
at least one video input for receiving an input video signal;
a video decoder for decoding the input video signal and outputting a decoded video signal in digital format; and
a mating connector having plurality of electrical contacts for cooperatively engaging a video storage/playback device, and the decoder coupled to at least one of the electrical contacts to apply the decoded video signal to the at least one of the electrical contacts.

17. The video capture module of claim 16, further comprising at least one video output for outputting an output video signal, the output video signal received by the video capture module over the mating connector from the video storage/playback device.

18. The video capture module of claim 17, wherein the video capture module is configured to pass the input video signal through to the video output.

19. The video capture module of claim 16, further comprising an audio input and an audio analog to digital converter for converting an audio signal received at the audio input.

20. The video capture module of claim 16, further comprising a transmitter for transmitting control signals to a stereo glasses assembly adapted to assist a user view three dimension video content.

21. In combination, a video storage and playback assembly, comprising:
the video capture module of claim 16; and
a video storage/playback device, the video storage/playback device including:
a re-writeable memory component for storing a plurality of files;
an input for receiving the decoded video signal; and
a video processor assembly for converting the decoded video signal into a video file and storing the video file on the memory component.

22. The video storage and playback assembly according to claim 21, wherein the video storage/playback device further comprises an output for outputting an output video signal and wherein the video processor assembly reads the video file from the memory component and converts the read video file to the output video signal.

23. The video storage and playback assembly according to claim 21, wherein the video storage/playback device further comprises an interface for establishing a data transfer link between the memory component and a general purpose computer such that the files stored by the memory component are readable by the computer and additional files can be written to the memory component by the computer.

24. The video storage and playback assembly according to claim 21, wherein the video processor assembly includes a microprocessor and a video encoder.

25. The video storage and playback assembly according to claim 24, wherein the video processor assembly further includes an audio digital to analog converter.

26. The video storage and playback assembly according to claim 21, wherein the memory component is a hard disk and drive assembly.

27. The video storage and playback assembly according to claim 21, wherein the video storage/playback device further comprises an expansion connector having a plurality of conductors for establishing electrical connection to the mating connector of the video capture module.

28. The video storage and playback assembly according to claim 21, wherein the video processor assembly executes logic to process video data of the video file.

29. The video storage and playback assembly according to claim 28, wherein the executed logic carries out at least one of resizing of the video data, resealing of the video data, and combinations thereof.

30. The video storage and playback assembly according to claim 28, wherein the executed logic converts the video data from two dimensional imaging to three dimensional imaging.

31. The video storage and playback assembly according to claim 28, wherein the executed logic converts the video file from a first file format to a second file format.

32. The video storage and playback assembly according to claim 28, wherein the executed logic compresses and decompresses the video file.
